(19) United States
(12) Patent Application Publication
(10) Pub. No.: US 2010/0022149 A1
(43) Pub. Date: Jan. 28, 2010

(54) ULTRA VIOLET PROTECTIVE PANEL

(76) Inventor: Mary Austin, (US)

Correspondence Address: KEITH L. JENKINS, 2222 NORTH MCQUEEN ROAD #2069, CHANDLER, AZ, 85225, US

(21) Appl. No.: 12/506,300

(22) Filed: Jul. 21, 2009

Related U.S. Application Data
(60) Provisional application No. 61/135,946, filed on Jul. 26, 2008.

(51) Int. Cl. B32B 5/26

(52) U.S. Cl. 442/239

(57) ABSTRACT

An ultraviolet protective panel having two layers of woven fabric that have UV transmissibility properties and combine to make an ultraviolet protective panel with a transmissibility to UVA and UVB radiation that is less than 1%. Muga silk or a flexible fabric treated with aluminum powder and impregnatable oil is preferably one of the two layers, and preferably the top or outer layer. Synthetic polymers are avoided. The panels are shaped to have multiple uses in producing articles of manufacture, including umbrellas, sleeves, awnings, tents, sheets, and garments. Each layers weave is different or the two weave orientations are not parallel. Garment sleeves may have straps for fastening and retaining and may have elastic panels.

### RELATED APPLICATIONS

This application claims the benefit of provisional patent application Ser. No. 61/135,946 filed Jul. 26, 2008 by the same inventor, which is hereby incorporated herein in its entirety.

### BACKGROUND

The need to protect human skin from damage and disease resulting from ultraviolet radiation exposure continues to be of interest, especially to those who have or have had skin cancer. Various “sun block” skin lotions are available on the open market. Their long-term usefulness is unknown. It must be understood that in the parlance of the industry, the word “block” does not, by itself, mean absolute or 100% blockage. For example, sunscreen lotions having SPFs ranging from 15% to 70% are all sold as “sun block”. Some umbrellas are advertised as impervious to 99.9% of UVA and UVB radiation, and claim a reflective surface.

Clothing and umbrellas block a certain amount of UV radiation, and interest in improving the ability of natural textiles to block UV radiation is keen. An article by D. Saravanan titled “UV Protection Textile Materials” in the AUTEX Research Journal, Vol 7. No. 1, March 2007, pointed to the need for improved UV absorbers to combine with fabrics with low Ultraviolet Protection Factors (UPF). Saravanan also pointed out that silks deteriorate under UV radiation over time, with mulberry silk deteriorating to a greater extent than muga silk. Muga silk is a silk from northeastern India. Muga silk fabric naturally blocks about 85% of UV radiation. According to Saravanan, UV transmissibility of transmissibility of fabric is due to interstitial spaces in the fabrics. Saravanan points to interest in various garments and umbrellas that are UV protective.

Accordingly, what is needed is a multi-use UV fabric panel to provide more than 99.8% UVA and UVB protection in a wide variety of applications, such as umbrellas, linens, clothing and accessories such as blankets, towels, hoods, wraps, blouses, shirts, slacks, skirts, socks, ponchos, jackets, coats, dresses, and hoods.

### SUMMARY OF THE INVENTION

An ultraviolet protective panel, including: a first fabric layer having a first weave and a first UV protective property; a second fabric layer having a second weave and a second UV protective property; and wherein said ultraviolet protective panel is transmissible to less than one percent of ambient UVA and UVB radiation. The ultraviolet protective panel, further including a shape adapted to be usable for making more than one ultraviolet protective article of manufacture. The ultraviolet protective panel, where the more than one ultraviolet protective article of manufacture includes at least two of: an umbrella covering; a sleeve; a legging; a square sheet having a central opening; a square sheet having no central opening; a rectangular sheet having a central opening; a rectangular sheet having no central opening; a tent; an awning; a shelter; and a garment. The ultraviolet protective panel, where the sleeve includes a first strap for fastening the sleeve to a user; a second strap for fastening the sleeve to a user; a third strap for retaining an end of the sleeve; or an elasticized panel. The ultraviolet protective panel, where the transmissibility of less than one percent of ambient UVA and UVB radiation includes transmissibility less than two-tenths of one percent of ambient UVA and UVB radiation. The ultraviolet protective panel, where the transmission of less than one percent of ambient UVA and UVB radiation includes transmissibility of none of the ambient UVA and UVB radiation. The ultraviolet protective panel, where the first fabric layer includes muga silk. The ultraviolet protective panel, where the second fabric layer includes muga silk. The ultraviolet protective panel, where the first fabric layer includes aluminum powder mixed with impregnatable oil. The ultraviolet protective panel, where the second fabric layer includes aluminum powder mixed with impregnatable oil. The ultraviolet protective panel, where the first weave is not the second weave. The ultraviolet protective panel, where the first weave is not parallel to the second weave. The ultraviolet protective panel, where the first UV protective property is not the second UV protective property. The ultraviolet protective panel, where neither the first nor second fabric layer includes synthetic polymers.

An ultraviolet protective panel, including: a first fabric layer having a first weave and a first UV protective property; a second fabric layer having a second weave and a second UV protective property; a shape adapted to be usable for making more than one ultraviolet protective article of manufacture; and where the ultraviolet protective panel is transmissible to less than one percent of ambient UVA and UVB radiation. The ultraviolet protective panel, where the more than one ultraviolet protective article of manufacture includes at least two of: an umbrella covering, where the umbrella covering covers one of: an umbrella frame; at least a portion of a top surface of a canopy of an umbrella; and at least a portion of a bottom surface of a canopy of an umbrella; a sleeve, where the sleeve includes a of: a first strap for fastening the sleeve to a user; a second strap for fastening the sleeve to a user; a third strap for retaining an end of the sleeve; and an elasticized panel; a legging; a square sheet having a central opening; a square sheet having no central opening; a rectangular sheet having a central opening; a rectangular sheet having no central opening; a tent; an awning; a shelter; and a garment. The ultraviolet protective panel, where either the first fabric layer or the second fabric layer includes either muga silk or aluminum powder mixed with impregnatable oil. The ultraviolet protective panel, where the first weave is not the second weave or the first weave is not parallel to the second weave. The ultraviolet protective panel, where the first UV protective property is not the second UV protective property.

An ultraviolet protective panel, including: a first fabric layer having a first weave and a first UV protective property; a second fabric layer having a second weave and a second UV protective property; a shape adapted to be usable for making more than one ultraviolet protective article of manufacture; and where the ultraviolet protective panel is transmissible to less than one percent of ambient UVA and UVB radiation; where the more than one ultraviolet protective article of manufacture includes at least two of: an umbrella covering, where the umbrella covering is adapted to cover one of: an umbrella frame; at least a portion of a top surface of a canopy of an umbrella; and at least a portion of a bottom surface of a canopy of an umbrella; a sleeve, where the sleeve includes: a first strap for fastening the sleeve to a user; a second strap for fastening the sleeve to a user; a third strap for retaining an end of the sleeve; and/or an elasticized panel; a legging; a square sheet having a central opening; a square sheet having no central opening; a rectangular sheet having a central opening; a rectangular sheet having no central opening; a tent; an awning; and a shelter; and a garment; where the first fabric layer or the second fabric layer includes muga silk or aluminum powder mixed with impregnatable oil; where the first weave is not the second weave; and the first weave is not parallel to the second weave; and where the first UV protective property is not the second UV protective property.

### BRIEF DESCRIPTION OF THE DRAWINGS

The above and other objects and advantages of the present invention will become more apparent from the following description taken in conjunction with the following drawings in which:

FIG. 1 is a perspective view illustrating an exemplary ultraviolet protective panel, and defining a section A-A′, according to a preferred embodiment of the present invention;

FIG. 2 is an enlarged vertical sectional view taken along the line A-A illustrating the exemplary ultraviolet protective panel in FIG. 1, according to a preferred embodiment of the present invention;

FIG. 3 is a perspective view illustrating an exemplary use of the exemplary ultraviolet protective panels of FIG. 1, according to a preferred embodiment of the present invention;

FIG. 4 is a perspective view illustrating an exemplary use of the exemplary ultraviolet protective panels of FIG. 1, according to a preferred embodiment of the present invention;

FIG. 5 is a top plan view illustrating a first alternative exemplary embodiment of ultraviolet protective panels and an exemplary use thereof, according to a preferred embodiment of the present invention;

FIG. 6 is a top plan view illustrating a second alternative exemplary embodiment of ultraviolet protective panels and an exemplary use thereof, according to a preferred embodiment of the present invention;

FIG. 7 is a perspective view illustrating a third alternative exemplary embodiment of ultraviolet protective panels and an exemplary use thereof, according to a preferred embodiment of the present invention;

FIG. 8 is a perspective view illustrating a fourth alternative exemplary embodiment of ultraviolet protective panels and an exemplary use thereof and defining a cross-section B-B′ and a longitudinal section C-C′, according to a preferred embodiment of the present invention;

FIG. 9 is an enlarged vertical cross-sectional view illustrating a detail of the fourth alternative exemplary embodiment of ultraviolet protective panels and an exemplary use thereof, wherein the cross section is taken along the line B-B′ in FIG. 8, according to a preferred embodiment of the present invention;

FIG. 10 is an enlarged vertical cross-sectional view illustrating a detail of the fourth alternative exemplary embodiment of ultraviolet protective panels and an exemplary use thereof, wherein the longitudinal section is taken along the line C-C′ in FIG. 8, according to a preferred embodiment of the present invention;

FIG. 11 is a bottom plan view illustrating the fourth alternative exemplary embodiment of ultraviolet protective panels and the exemplary use thereof shown in FIG. 8, according to a preferred embodiment of the present invention;

FIG. 12 is a perspective view illustrating a fifth alternative exemplary embodiment of ultraviolet protective panels and an exemplary use thereof, according to a preferred embodiment of the present invention; and

FIG. 13 is a perspective view illustrating a sixth alternative exemplary embodiment of ultraviolet protective panels and an exemplary use thereof, according to a preferred embodiment of the present invention.

### DETAILED DESCRIPTION OF THE PREFERRED EMBODIMENTS

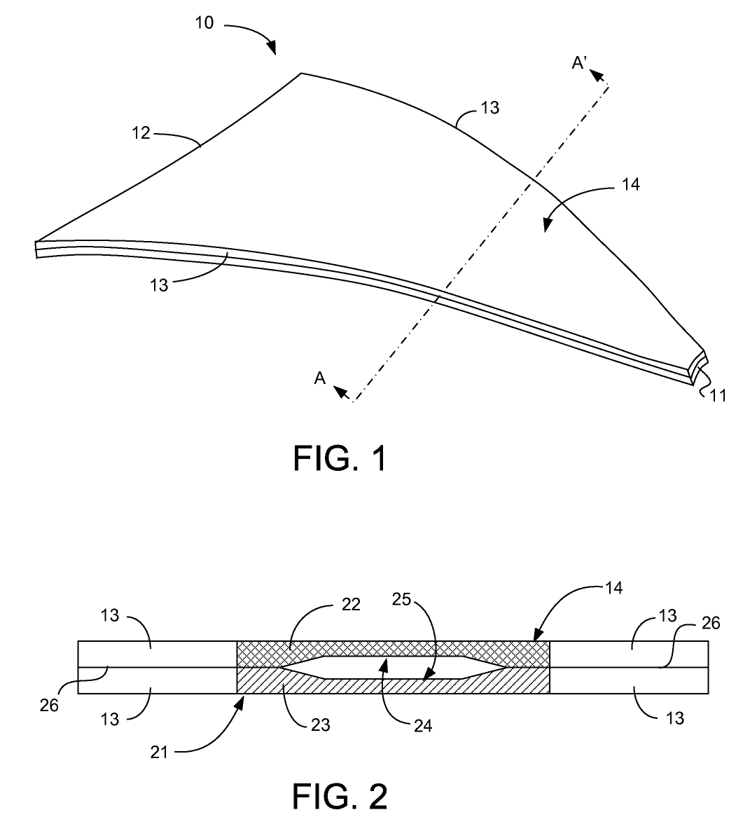

FIG. 1 is a perspective view illustrating an exemplary ultraviolet protective panel 10, and defining a section A-A′, according to a preferred embodiment of the present invention. Ultraviolet protective panel 10 includes inner edge 11, outer edge 12, side edges 13, and top surface 14. Ultraviolet protective panel 10 has a shape that is adaptable to multiple uses, including usefulness in making umbrellas, sleeves, and multi-panel sheets for clothing, awnings, and the like. Ultraviolet protective panel 10 is flexible.

FIG. 2 is an enlarged vertical sectional view taken along the line A-A illustrating the exemplary ultraviolet protective panel in FIG. 1, according to a preferred embodiment of the present invention. Ultraviolet protective panel 10 is made of two layered sheets of different fabric materials 22 and 23. Top layer fabric material 22 has inner surface 24 and bottom layer fabric material 23 has inner surface 25. Fabric material layers 22 and 23 are connected to each other at side edges 13 by methods readily used by those skilled in the art such as stitching, adhesives, cords, or heat fusion, and may form a side edge seam 26. In a particular embodiment, inner surface 24 may abut inner surface 25 over the entire areas of inner surface 24 and inner surface 25. Preferably, fabric material layers 22 and 23 are made from commercially available flexible woven fabrics of natural or man-made materials. Preferably, the weave of fabric material layer 22 is different from the weave of fabric material layer 23. Preferably, the weave of each of fabric material layers 22 and 23 is a tight weave, with minimum interstitial spaces. The tightness of the weave for a particular application must be determined based on cost (tighter weave means higher cost) and overall contribution to preventing UV transmissibility. In a particular embodiment where the weaves of fabric material layers 22 and 23 are similar, the orientation of the weaves of the fabric in the assembled ultraviolet protective panel 10 should not he parallel. Preferably, fabric material layers 22 and 23 contain no synthetic polymers.

At least one of the fabric material layers 22 and 23 is preferably muga silk. In an alternative embodiment, the fabric material layer 22 is preferably a fabric with a reflective top surface 14, such as an flexible fabric material 22 treated with aluminum powder mixed with impregnatable oil. For example, the treating compound may include aluminum powder having a grain fineness such that 99% passes through a 325 mesh (a 15-micron grain size) that makes up 65(±2%) of a mixture with number 200 solvent oil and naphtha. A first layer of muga silk or treated flexible fabric material 22 is combined with a second layer of flexible fabric material 23 in order to block more than 99 percent of ultraviolet (which gives it an ultraviolet protection factor (UPF) rating of 50+, a commercially used scale that identifies a device's ultraviolet protection value). In a preferred embodiment, the combined first and second layers 23 and 23 transmit less than 0.02% of the ambient UVA and UVB radiation. In a more preferred embodiment, the combined first and second layers 23 and 23 transmit none of the ambient UVA and UVB radiation. Blocking may be by reflection or absorption. In a particular embodiment, a flexible fabric with the reflective surface may be the top fabric material layer 22 and the mugs silk may be the bottom fabric material layer 23. In a preferred embodiment, top fabric material layer 22 of muga silk is assembled with a bottom fabric material layer 23 of non-silk material. In another preferred embodiment, top fabric material layer 22 of muga silk is assembled with a bottom fabric material layer 23 of muga silk. In another preferred embodiment, top flexible fabric material layer 22, treated with aluminum powder mixed with impregnatable oil, is assembled with a bottom fabric material layer 23 of muga silk.

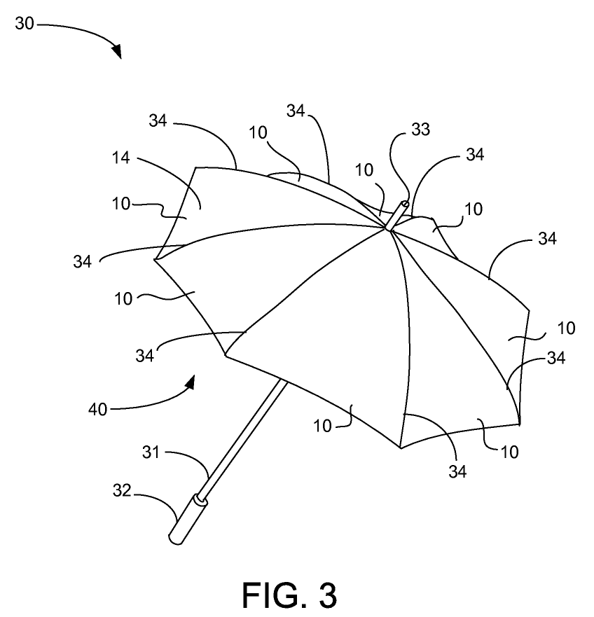

FIG. 3 is a perspective view illustrating an exemplary use of the exemplary ultraviolet protective panels 10 of FIG. 1, according to a preferred embodiment of the present invention. Umbrella 30 has an umbrella frame made up of a shaft 31, handle 32, shaft tip 33, and ribs 34. The frame is a conventional, commercially available device that will be readily understood by those skilled in the art. The ultraviolet protective umbrella covering 40 is comprised of a plurality of ultraviolet protective panels 10. The ultraviolet protective panels 10 are secured to the umbrella 30 at the shaft tip 33 and to the ribs 34 using devices known to those skilled in the art such as commercially available adhesives, hook and loop fasteners, stitching, or anchors. Ultraviolet protective umbrella covering 40 may of various sizes and numbers of ultraviolet protective panels 10. In a preferred embodiment, at least one of top fabric material layer 22 and bottom fabric material layer 23 is resistant to penetration by rain water.

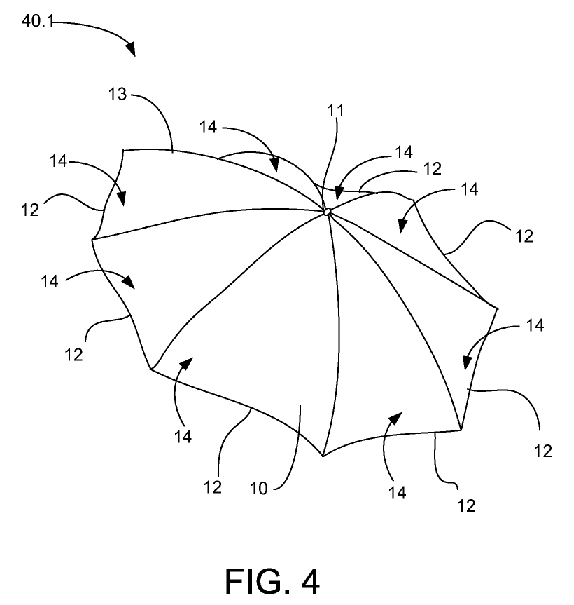

FIG. 4 is a perspective view illustrating an exemplary use of the exemplary ultraviolet protective panels of FIG. 1, according to a preferred embodiment of the present invention. Ultraviolet protective covering 40.1 is comprised of ultraviolet protective panels 10. The ultraviolet protective panels 10 are connected to each other at side edges 13 by methods known to those skilled in the art such as stitching, adhesives, or heat fusion. Ultraviolet protective covering 40.1 may be used as an add-on to an existing umbrella, either as a top covering or as an under covering. In an embodiment wherein ultraviolet protective covering 40.1 is used as an under covering, it is preferable that ultraviolet protective covering 40.1 be slightly smaller than the umbrella canopy that ultraviolet protective covering 40.1 is coupled to. Ultraviolet protective covering 40.1 may also be adapted to use as a shelter or awning.

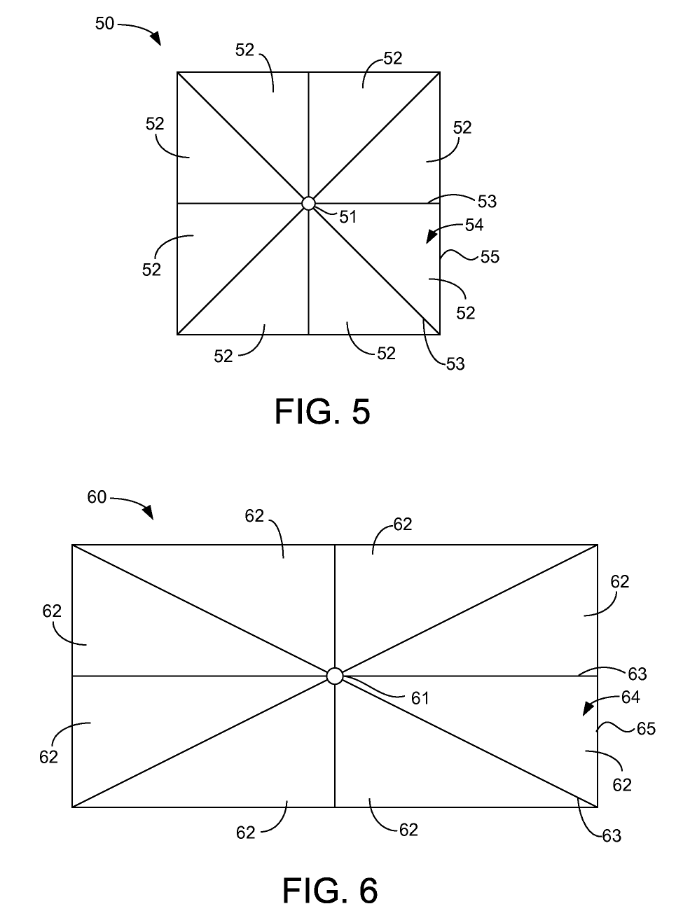

FIG. 5 is a top plan view illustrating a first alternative exemplary embodiment of ultraviolet protective panels 52 and an exemplary use thereof, according to a preferred embodiment of the present invention. In common with the previously described embodiment designated in FIG. 1 through FIG. 4, the square sheet 50 has ultraviolet protective panels 52, inner edges 51 (one of eight labeled), outer edges 55 (one of eight labeled), side edges 53 (two of eight labeled), and outer surfaces 54 (one of eight labeled). The difference between ultraviolet protective panel 10 and ultraviolet protective panel 52 is the shape: the construction and materials are the same. Ultraviolet protective panel 52 is an isosceles right triangle with minor modification for edge 51. Ultraviolet protective panel 52 may be used to assemble approximately square quarter sections of two ultraviolet protective panels 52, four of which are then assembled into a square sheet 50. Square sheets 50 may be assembled together to make various fabric structures such as umbrellas, tents, awnings, and clothing. Those of skill in the art, enlightened by the present disclosure, will appreciate that square sheets 50 may alternatively be assembled with edges 51 on the outer corners or middles of two opposing sides of square sheet 50 for those embodiments where a central opening for a tent pole, umbrella shaft, awning support, vent, or the like is not desired.

FIG. 6 is a top plan view illustrating a second alternative exemplary embodiment of ultraviolet protective panels 62 and an exemplary use thereof, according to a preferred embodiment of the present invention. In common with the previously described embodiment designated in FIG. 1 through FIG. 4, the square sheet 60 has ultraviolet protective panels 62, inner edges 61 (one of eight labeled), outer edges 65 (one of eight labeled), side edges 63 (two of eight labeled), and outer surfaces 64 (one of eight labeled). The difference between ultraviolet protective panel 10 and ultraviolet protective panel 62 is the shape: the construction and materials are the same. Ultraviolet protective panel 62 is a right triangle with minor modification for edge 61. Ultraviolet protective panel 62 may be used to assemble approximately rectangular quarter sections of two ultraviolet protective panels 62, four of which are then assembled into a rectangular sheet 60. Rectangular sheets 60 may be assembled together to make various fabric structures such as umbrellas, tents, awnings, and clothing. Those of skill in the art, enlightened by the present disclosure, will appreciate that rectangular sheets 60 may alternatively be assembled with edges 61 on the outer corners or middies of two opposing sides of rectangular sheet 60 for those embodiments where a central opening for a tent pole, umbrella shaft, awning support, vent, or the like is not desired.

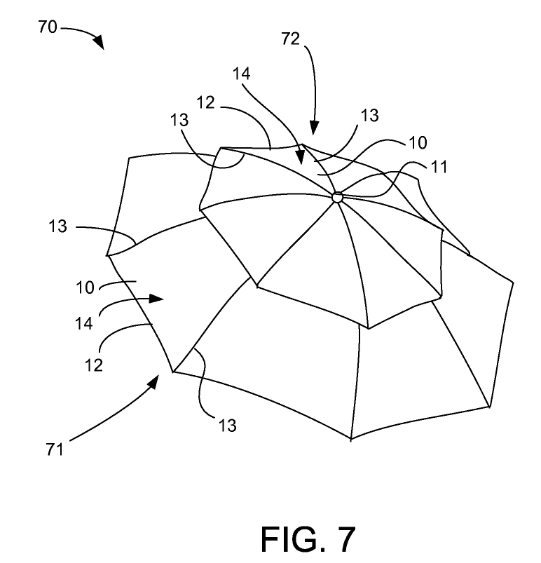

FIG. 7 is a perspective view illustrating a third alternative exemplary embodiment of ultraviolet protective panels 10 and an exemplary use thereof, according to a preferred embodiment of the present invention. Dual-canopy 70 comprises lower ultraviolet protective canopy 71 and upper ultraviolet protective canopy 72 coupled together. Each of lower ultraviolet protective canopy 71 and upper ultraviolet protective canopy 72 are made like ultraviolet protective covering 40.1, but are of different sizes. In an alternative embodiment, lower ultraviolet protective canopy 71 and upper ultraviolet protective canopy 72 are the same size.

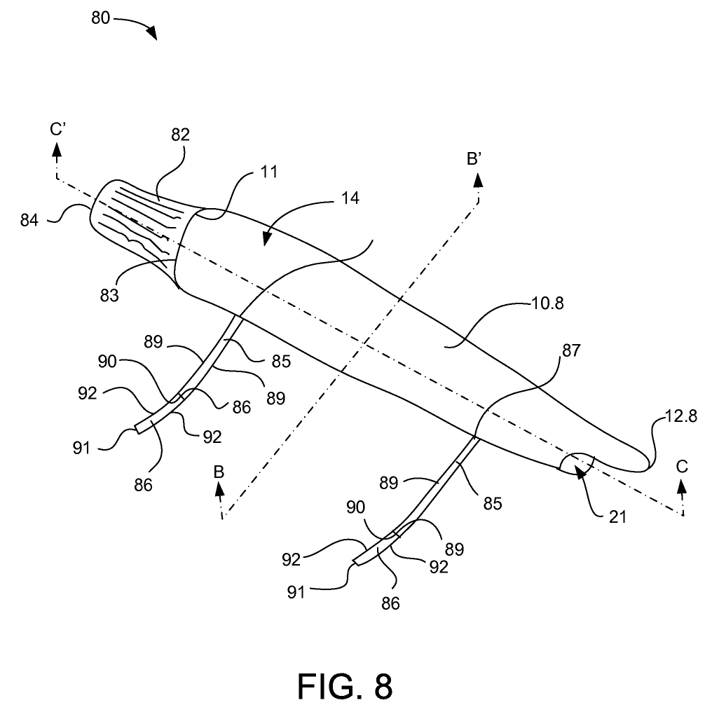

FIG. 8 is a perspective view illustrating a fourth alternative exemplary embodiment of ultraviolet protective panels 10.8 and an exemplary use thereof and defining a cross-section B-B′ and a longitudinal section C-C′, according to a preferred embodiment of the present invention. Ultraviolet protective garment sleeve 80 includes the ultraviolet protective panel 10.8, inner edge 11.8, outer edge 12.8, outer surface 14, under surface 21, elasticized panel 81, elasticized panel outer surface 82, elasticized panel lower edge 83, elasticized panel upper edge 84, securing straps 85, fastening device 86, securing strap top edge 87, securing strap bottom edge 88, securing strap side edges 89, fastening device top edge 90, fastening device bottom edge 91, and fastening device side edges 92. Garment sleeve 80 may be worn independently of other clothing, or as part of a shirt or jacket. Edge 12.8 is shaped differently from edge 12 of ultraviolet protective panel 10 to define a portion that covers the hand of the wearer. Securing straps 85 are used to secure the sleeve 80 to the wearer's arm using fastening devices 86, which may be hook and loop fasteners or other fastening devices known in the art. In an alternate embodiment, ultraviolet protective garment sleeve 80 maybe a legging.

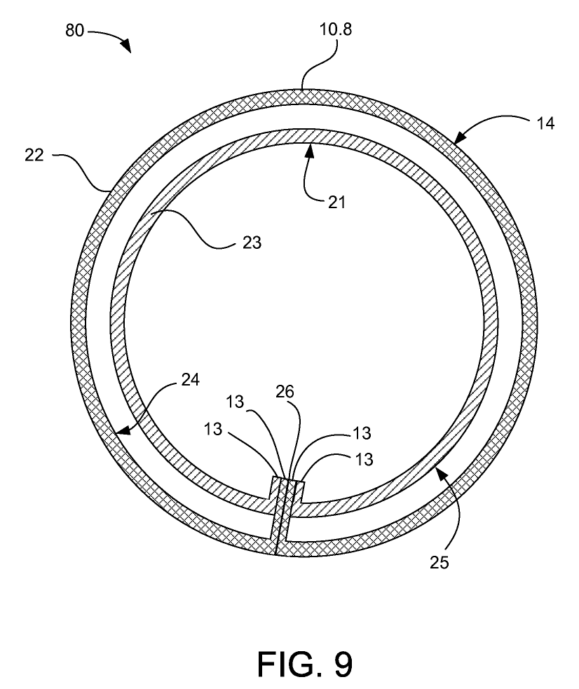

FIG. 9 is an enlarged vertical cross-sectional view illustrating a detail of the fourth alternative exemplary embodiment 80 of ultraviolet protective panels 10.8 and an exemplary use thereof, wherein the cross section is taken along the line B-B′ in FIG. 8, according to a preferred embodiment of the present invention. The gap shown between top fabric material layer 22 and bottom fabric material layer 23 is enlarged for illustrative purpose. In a preferred embodiment, surface 24 continuously abuts surface 25. In another preferred embodiment, surface 24 intermittently abuts surface 25. Seam. 26 may be made by stitching with the sleeve 80 turned inside-out. Bottom fabric material layer 23 is preferably a fabric that is comfortable against the skin, within the constraints of the weave, as previously discussed. Muga silk is very comfortable against the skin.

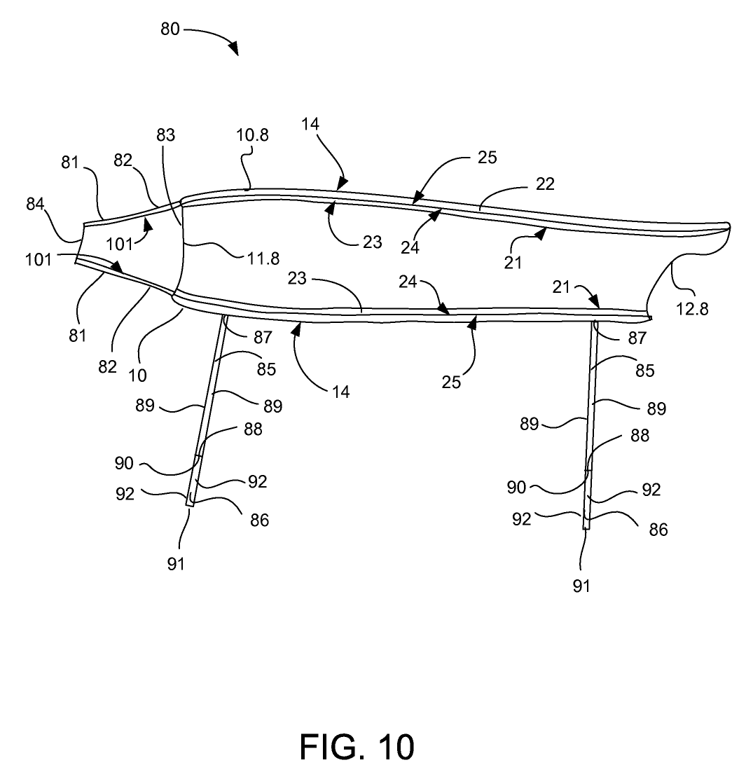

FIG. 10 is an enlarged vertical cross-sectional view illustrating a detail of the fourth alternative exemplary embodiment 80 of ultraviolet protective panels 10.8 and an exemplary use thereof, wherein the longitudinal section is taken along the line C-C′ in FIG. 8, according to a preferred embodiment of the present invention. Ultraviolet protective panel 10.8 differs from ultraviolet protective panel 10 in that inert edge 11.8 is larger, outer edge 12.8 is curved, and the panel is dimensioned to be an ultraviolet protective sleeve 80. Ultraviolet protective garment sleeve 80 includes the ultraviolet protective panel 10.8, inner edge 11.8, outer edge 12.8, outer surface 14, under surface 21, upper fabric material layer 22, lower fabric material layer 23, top fabric material layer inner surface 24, bottom fabric material layer inner surface 25, elasticized panel 81, elasticized panel outer surface 82, elasticized panel lower edge 83, elasticized panel upper edge 84, securing strap 85, fastening device 86, securing strap top edge 87, securing strap bottom edge 88, securing strap side edge 89, fastening device top edge 90, fastening device bottom edge 91, fastening device side edge 92, and elasticized panel inner surface 101. Ultraviolet protective garment sleeve 80 is shown with surface 24 continuously abutting surface 25. Ultraviolet protective garment sleeve 80 has elasticized panel 81 with elasticized panel inner surface 101. Elasticized panel 81 should be made of commercially available elastic fabric, woven or unwoven, of natural or man-made materials. The ultraviolet protective panel 10.8 is connected to the elasticized panel 81 at inner edge 11.8 and elasticized panel lower edge 83 by methods known to those skilled in the art such as stitching, adhesives, or heat fusion. The securing strap 85 is preferably made from commercially available flexible fabrics, woven or unwoven, of natural or man-made materials, and is affixed to the outer surface 14 by methods known to those skilled in the art such as stitching, adhesives, or heat fusion. Fastening device 86 can be made of commercially available adhesives, hook and loop fasteners, buckle, snaps, laces, hooks, or any other item known to those skilled in the art.

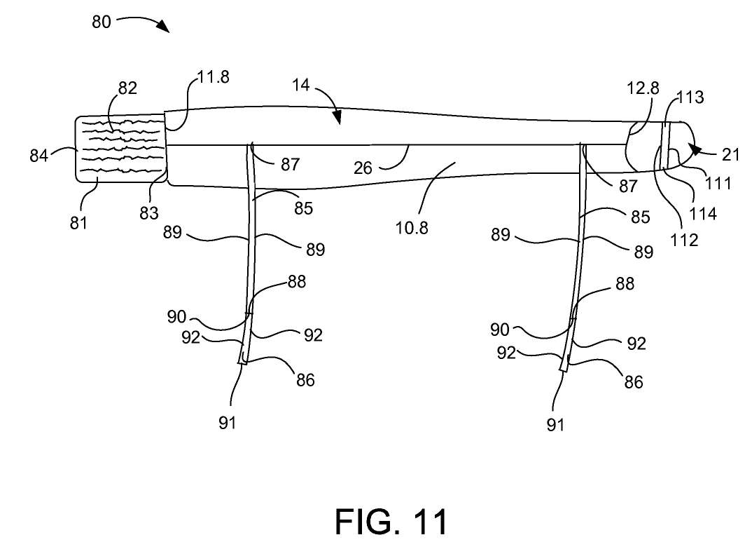

FIG. 11 is a bottom plan view illustrating the fourth alternative exemplary embodiment 80 of ultraviolet protective panels 10.8 and the exemplary use thereof shown in FIG. 8, according to a preferred embodiment of the present invention. Seam 26 is visible, and straps 85 can be attached by sewing securing strap top edge 87 into seam 26. Ultraviolet protective garment sleeve 80 includes the ultraviolet protective panel 10.8, inner edge 11.8, outer edge 12.8, outer surface 14, under surface 21, 26, elasticized panel 81, elasticized panel outer surface 82, elasticized panel lower edge 83, elasticized panel upper edge 84, securing strap 85, fastening device 86, securing strap top edge 87, securing strap bottom edge 88, securing strap side edge 89, fastening device top edge 90, fastening device bottom edge 91, and fastening device side edge 92. Also seen are elasticized strap 111, elasticized strap side edge 112, elasticized strap upper edge 113, and elasticized strap lower edge 114. Elasticized strap 111 is preferably made of commercially available elastic fabric, woven or unwoven, of natural or man-made materials, and is affixed to the ultraviolet protective panel 10.8 at elasticized strap upper edge 113, elasticized strap lower edge 114, and the outer edge 12 by methods known to those skilled in the art such as stitching, adhesives, or heat fusion. Elasticized strap 111 is useful to retain the right end of the ultraviolet protective garment sleeve 80 in place about a user's hand. The Ultraviolet protective garment sleeve 80 has numerous uses. For example, in addition to shielding from more than 99% of the ambient UVA or UVB radiation, it can shield against fluids or other objects that may come in contact with it. Alternately, the covering can be used as a legging. Those skilled in the art, enlightened by the present disclosure, will see additional application for the ultraviolet protective garment sleeve 80 for use with animals, such as horses, where accident or medical condition has removed hair and exposed the animal's skin to direct sunlight.

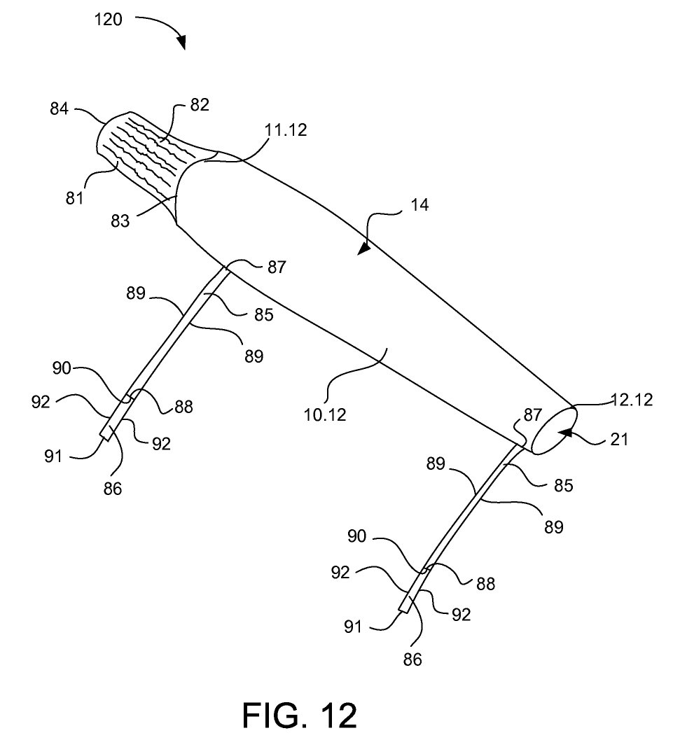

FIG. 12 is a perspective view illustrating a fifth alternative exemplary embodiment 120 of ultraviolet protective panels 10.12 and an exemplary use thereof, according to a preferred embodiment of the present invention. Ultraviolet protective garment sleeve 120 has the ultraviolet protective panel 10.12, inner edge 11.12, outer edge 12.12, outer surface 14, bottom surface 21, elasticized panel 81, elasticized panel outer surface 82, elasticized panel lower edge 83, elasticized panel upper edge 84, securing strap 85, fastening device 86, securing strap top edge 87, securing strap bottom edge 88, securing strap side edge 89, fastening device top edge 90, fastening device bottom edge 91, and fastening device side edge 92. Outer edge 12.12 is straight, being more like outer edge 12 than outer edge 12.8. Ultraviolet protective garment sleeve 120 lacks hand protection, and so is intended for wear with gloves or mittens.

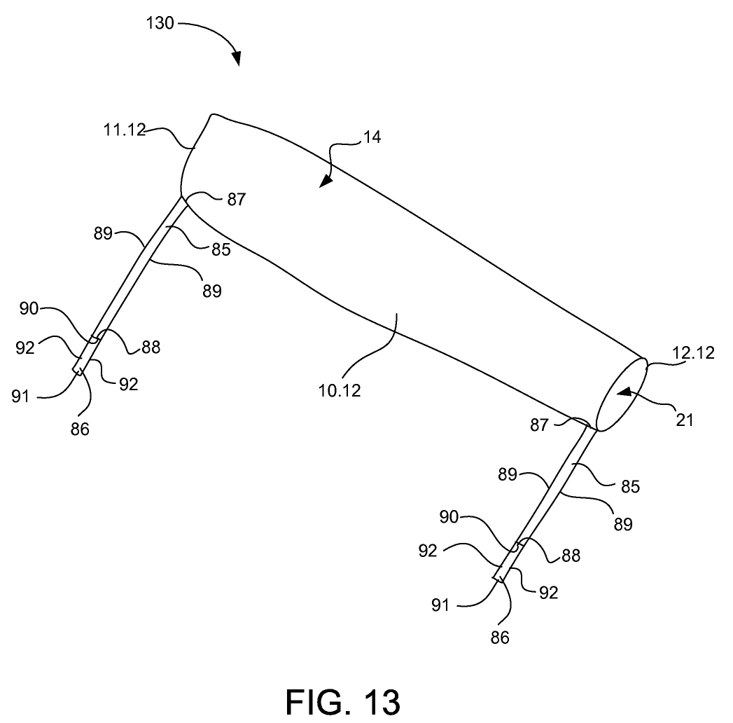

FIG. 13 is a perspective view Illustrating a sixth alternative exemplary embodiment 130 of ultraviolet protective panels and an exemplary use thereof, according to a preferred embodiment of the present invention. Ultraviolet protective garment sleeve 130 includes the ultraviolet protective panel 10.12, inner edge 11.12, outer edge 12.12, outer surface 14, under surface 21, securing straps 85 now located at the ends of ultraviolet protective garment sleeve 130, fastening device 86, securing strap top edge 87, securing strap bottom edge 88, securing strap side edge 89, fastening device top edge 90, fastening device bottom edge 91, fastening device side edge 92 and lacks elasticized panel 81. Ultraviolet protective garment sleeve 130 is specially adapted to protect a portion of a user's limb that needs special protection from UVA and UVB radiation.

I claim:

1. An ultraviolet protective panel, comprising:
a. a first fabric layer having a first weave and a first UV protective property;
b. a second fabric layer having a second weave and a second UV protective property; and
c. wherein said ultraviolet protective panel is transmissible to less than 1% of ambient UVA and UVB radiation.

2. The ultraviolet protective panel of claim 1, further comprising a shape adapted to be usable for making more than one ultraviolet protective article of manufacture.

3. The ultraviolet protective panel of claim 2, wherein said more than one ultraviolet protective article of manufacture comprises at least two of:
a. an umbrella covering;
b. a sleeve;
c. a legging;
d. a square sheet having a central opening;
e. a square sheet having no central opening;
f. a rectangular sheet having a central opening;
g. a rectangular sheet having no central opening;
h. a tent;
i. an awning;
j. a shelter; and
k. a garment.

4. The ultraviolet protective panel of claim 3, wherein said sleeve comprises at least one of:
a. a first strap for fastening said sleeve to a user;
b. a second strap for fastening said sleeve to a user;
e. a third strap for retaining an end of said sleeve; and
d. an elasticized panel.

5. The ultraviolet protective panel of claim 1, wherein said transmissibility of less than 1% of ambient UVA and UVB radiation comprises transmissibility of less than 0.2% of ambient UVA and UVB radiation.

6. The ultraviolet protective panel of claim 1, wherein said transmission of less than 1% of ambient UVA and UVB radiation comprises transmissibility of 0.0% of ambient UVA and UVB radiation.

7. The ultraviolet protective panel of claim 1, wherein said first fabric layer comprises muga silk.

8. The ultraviolet protective panel of claim 1, wherein said second fabric layer comprises muga silk.

9. The ultraviolet protective panel of claim 1, wherein said first fabric layer comprises aluminum powder mixed with impregnatable oil.

10. The ultraviolet protective panel of claim 1, wherein said second fabric layer comprises aluminum powder mixed with impregnatable oil.

11. The ultraviolet protective panel of claim 1, wherein said first weave is not said second weave.

12. The ultraviolet protective panel of claim 1, wherein said first weave is not parallel to said second weave.

13. The ultraviolet protective panel of claim 1, wherein said first UV protective property is not said second UV protective property.

14. The ultraviolet protective panel of claim 1, wherein neither said first nor second fabric layer comprises synthetic polymers.

15. An ultraviolet protective panel, comprising:
a. a first fabric layer having a first weave and a first UV protective property;
b. a second fabric layer having a second weave and a second UV protective property;
c. a shape adapted to be usable for making more than one ultraviolet protective article of manufacture; and
d. wherein said ultraviolet protective panel is transmissible to less than 1% of ambient UVA and UVB radiation.

16. The ultraviolet protective panel of claim 15, wherein said more than one ultraviolet protective article of manufacture comprises at least two of:
a. an umbrella covering, wherein said umbrella covering covers one of:
i. an umbrella frame;
ii. at least a portion of a top surface of a canopy of an umbrella; and
iii. at least a portion of a bottom surface of a canopy of an umbrella;
b. a sleeve, wherein said sleeve comprises at least one of:
i. a first strap for fastening said sleeve to a user;
ii. a second strap for fastening said sleeve to a user;
iii. a third strap for retaining an end of said sleeve; and
iv. an elasticized panel;
c. a legging;
d. a square sheet having a central opening;
e. a square sheet having no central opening;
f. a rectangular sheet having a central opening;
g. a rectangular sheet having no central opening;
h. a tent;
i. an awning;
j. a shelter; and
k. a garment.

17. The ultraviolet protective panel of claim 15, wherein at least one of said first fabric layer and said second fabric layer comprises one of:
a. muga silk;
b. aluminum powder mixed with impregnatable oil.

18. The ultraviolet protective panel of claim 15, wherein at least one of:
a. said first weave is not said second weave; and
b. said first weave is not parallel to said second weave.

19. The ultraviolet protective panel of claim 15, wherein said first UV protective property is not said second UV protective property.

20. An ultraviolet protective panel, comprising:
a. a first fabric layer having a first weave and a first UV protective property;
b. a second fabric layer having a second weave and a second UV protective property;
c. a shape adapted to he usable for making more than one ultraviolet protective article of manufacture; and
d. wherein said ultraviolet protective panel is transmissible to less than 1% of ambient UVA and UVB radiation;
e. wherein said more than one ultraviolet protective article of manufacture comprises at least two of:
i. an umbrella covering, wherein said umbrella covering is adapted to cover one of:
1. an umbrella frame;
2. at least a portion of a top surface of a canopy of an umbrella; and
3. at least a portion of a bottom surface of a canopy of an umbrella;
ii. a sleeve, wherein said sleeve comprises at least one of:
1. a first strap for fastening said sleeve to a user;
2. a second strap for fastening said sleeve to a user;
3. a third strap for retaining an end of said sleeve; and
4. an elasticized panel;
iii. a legging;
iv. a square sheet having a central opening;
v. a square sheet having no central opening;
vi. a rectangular sheet having a central opening;
vii. a rectangular sheet having no central opening;
viii. a tent;
ix. an awning; and
x. a shelter; and
xi. a garment;
f. wherein at least one of said first fabric layer and said second fabric layer comprises one of:
i. muga silk;
ii. aluminum powder mixed with impregnatable oil;
g. wherein at least one of:
i. said first weave is not said second weave; and
ii. said first weave is not parallel to said second weave; and
h. wherein said first UV protective property is not said second UV protective property.
